(19) United States
(12) Patent Application Publication
(10) Pub. No.: US 2026/0183917 A1
(43) Pub. Date: Jul. 2, 2026

(54) FASTENING TOOL DRIVER ASSEMBLY WITH INTERNAL LIFTING MEMBER

(71) Applicant: BLACK & DECKER, INC., New Britain, CT (US)

(72) Inventor: MERRILL A. MYERS, III, Parkville, MD (US)

(21) Appl. No.: 19/546,042

(22) Filed: Feb. 20, 2026

Related U.S. Application Data
(63) Continuation of application No. PCT/US2024/043509, filed on Aug. 22, 2024.
(60) Provisional application No. 63/533,974, filed on Aug. 22, 2023.

(51) Int. Cl. B25C 1/06

(52) U.S. Cl. CPC B25C 1/06

(57) ABSTRACT

A fastening tool having an internal lifter spring that can include a profile of a driver member. The driver profile interacts with flywheel, rails, and bumpers. The driver blade interacts with the nosepiece, door, and fasteners. The lifter spring applies a force between the driver blade and driver body to induce lifting the driver profile away from the flywheel. A retaining member limits the range of motion between driver blade and driver profile.

### CROSS-REFRENCE TO RELATED APPLICATIONS

This application claims priority under 35 U.S.C. § 120 as a continuation of PCT Patent Application No. PCT/US2024/043509, filed August 22, 2024, which claims priority to U.S. Provisional Patent Application No. 63/533,974, filed August 22, 2023, entitled “Fastening Tool Driver Assembly with Internal Lifting Member. The entirety of the above applications is incorporated herein by reference.

### BACKGROUND OF THE INVENTION

### Field of Invention

The present invention relates, in general, to the field of power tools. In particular, the present invention relates to a fastening or driving tool, such as a nailer and more particularly to improvements in reducing the size and weight of the tool. In particular, the present invention relates to a fastening tool having a driver member that can return to the home position without contacting the flywheel.

### Description of the Related Art

Different types of fastening tools are known including portable pneumatically actuated devices, electrically actuated devices, hammer actuated devices, manual actuated devices, etc. Fastening tools, such as power nailers and staplers have become relatively common place in the construction industry. Battery-powered nailers are popular in the market.

A common characteristic of all these types of fastening tools is the provision of a drive track, a fastener driving element mounted in the drive track and a magazine assembly for receiving a supply of fasteners in stick formation and feeding successive leading fasteners in the stick laterally into the drive track to be driven outwardly thereof by the fastener driving element.

In a fastening tool, for example, fasteners, are driven into a workpiece by a driver blade or driver through a process known as a "drive" or "drive cycle”. Generally, a drive cycle involves the driver member striking a fastener head during a drive stroke to an extended position, and returning to a home or returned position during a return stroke.

Existing fastening tools have a driver member that has a longitudinal body that includes a driver body and an attached driver blade. The forward surface of the driver body is closed, and the driver blade is retained in the driver body by a clip that is inserted laterally with respect to the longitudinal body.

In an existing fastening tool, the nosepiece includes a nose portion along which a driver member drives a fastener into a workpiece, and a door portion that covers the nose portion. During the drive cycle, the driver member reciprocates in a space between the nose portion and the door portion.

As such, the fastening tools that are available may not provide the user with a desired degree of flexibility and freedom due to the size of the tool relative to the space in which the fastener is to be driven. As such, the user may be challenged to use the tool in small spaces.

Another consideration is that the fastening tool driver profile of the driver member causes noise and vibration if it contacts the flywheel at rest. However, to make flywheel nailers more compact, the length of the profile body is minimized, reducing the surface area available to directly interact with a statically mounted lifting spring/member.

Accordingly, there is a need in the art for a fastening tool that is smaller in length from tip of the nosepiece to the back end thereof, but is capable of reliably delivering the same force as larger fastening tools. There is also a need in the art for a fastening tool that and ensures that the driver profile of the driver member does not contact the flywheel at rest and can move the driver member out of the way of the flywheel during the return stroke.

### SUMMARY OF THE INVENTION

A fastening tool having has an internal lifter spring that can include a profile body or driver profile of a driver member. The profile body or driver profile interacts with flywheel, rails, and bumpers. The driver blade interacts with the nosepiece, door, and fasteners. The lifter spring applies a force between the driver blade and driver profile or driver body to induce lifting the driver profile away from the flywheel. In an embodiment, a driver blade retaining element or retaining member, such as a clip or a rivet, limits range of motion between driver blade and driver profile.

In an embodiment, the fastening tool may be a nailer or a stapler.

Additional features and benefits of the present invention are described, and will be apparent from, the accompanying drawings and the detailed description below.

### BRIEF DESCRIPTION OF THE DRAWINGS

The numerous advantages of the present invention may be better understood by those skilled in the art by reference to the accompanying Figures. In the drawings, like reference numerals designate corresponding parts throughout the several views.

FIG. 1 illustrates a fastening tool according to an embodiment of the present invention;

FIG. 2 illustrates the fastening tool of FIG. 4 with the housing removed;

FIG. 3 illustrates a partial view of the driver blade guide in the tool of FIG. 1;

FIGS. 4A and 4B illustrate the driver member in the tool of FIG. 1;

FIG. 5 illustrates a top perspective and exploded view of the driver member in the tool of FIG. 1;

FIG. 6 illustrates a side view of the driver member in the tool of FIG. 1 showing the driver blade in the driving position and in the lifted position; and

FIG. 7 illustrates a cross-sectional enlarged view of the lifter in the driver member in the tool of FIG. 1; and

FIGS. 8A and 8B illustrate a second embodiment of a driver member in the tool of FIG. 1.

Corresponding reference names and/or numerals indicate corresponding parts throughout the several views of the drawings.

### DETAILED DESCRIPTION OF THE INVENTION

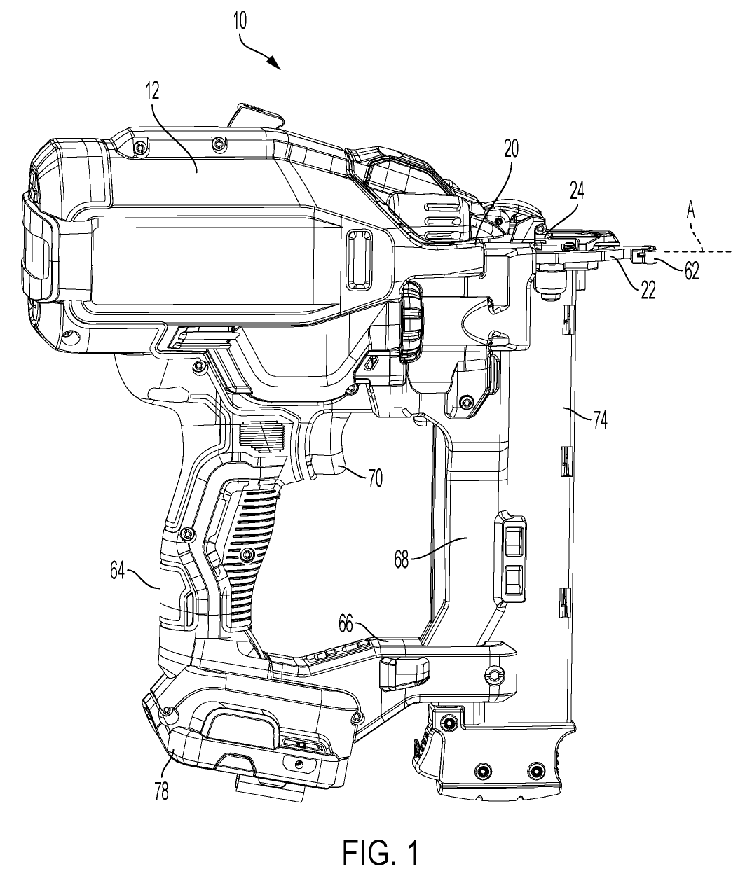

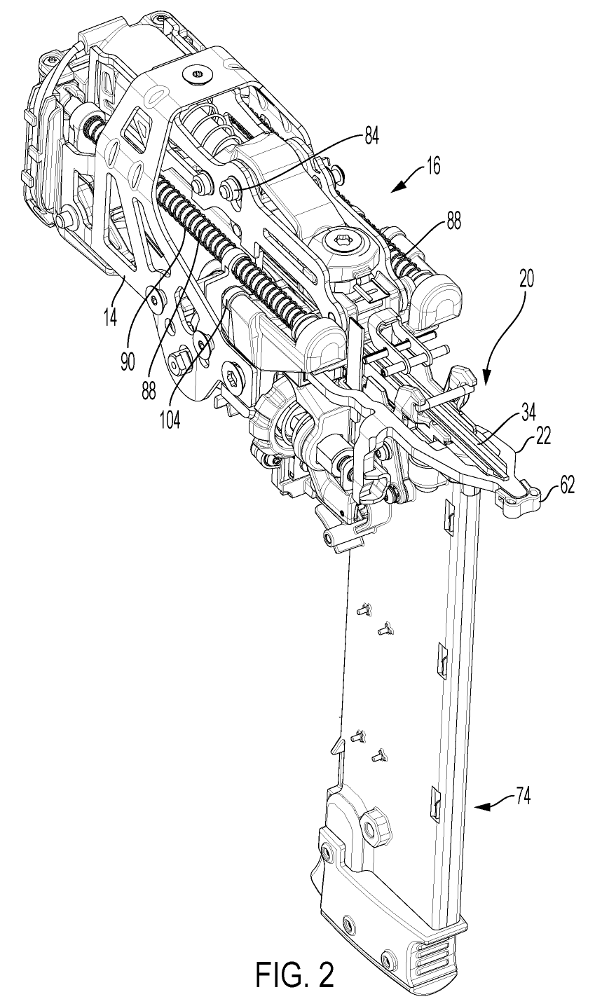

With reference to FIGS. 1 and 2 of the drawings, a fastening tool constructed in accordance with the teachings of the present invention is illustrated. According to several aspects, the fastening tool is a battery powered nailer for driving nails into a workpiece. The fastening tool may include a housing, a frame, a drive motor assembly, a control unit, a nosepiece assembly extending forward of and fixed to the housing, a magazine assembly connected to a nose portion of the nosepiece assembly and a battery mount for mounting a battery pack (not shown).

With reference to FIGS. 1 and 2 of the drawings, a fastening tool 10 constructed in accordance with the teachings of the present invention is illustrated. According to several aspects, the fastening tool 10 is a cordless nailer for driving fasteners such as nails into a workpiece. The fastening tool 10 may include a housing 12, a backbone or frame 14 supported within the housing, a drive motor assembly 16, a controller or control module 18, a nosepiece assembly 20 extending forward of and fixed to the housing 12. The nosepiece assembly 20 includes a nose portion 22 that can be placed against the workpiece for driving a fastener. The nosepiece assembly 20 defines a fastener drive track 24 through which the fasteners F, such as nails or staples, are driven during a drive stroke. The fastener drive track 24 is connected to a drive channel 26. The drive channel 26 is defined within the housing interior and a within which, a driver member 30 is reciprocally mounted on a return mechanism 88 for movement along a fastening tool drive axis A, to drive the fastener . A magazine assembly 74 is carried by the housing 12 and is configured to hold a plurality of fasteners and configured to present a lead fastener of the plurality of fasteners into a drive channel 26.

With additional reference to FIG. 2, the frame 14 may be a structural element upon which the drive motor assembly 16, control module 18, the nosepiece assembly 20 and/or the magazine assembly 74 may be fully or partially mounted.

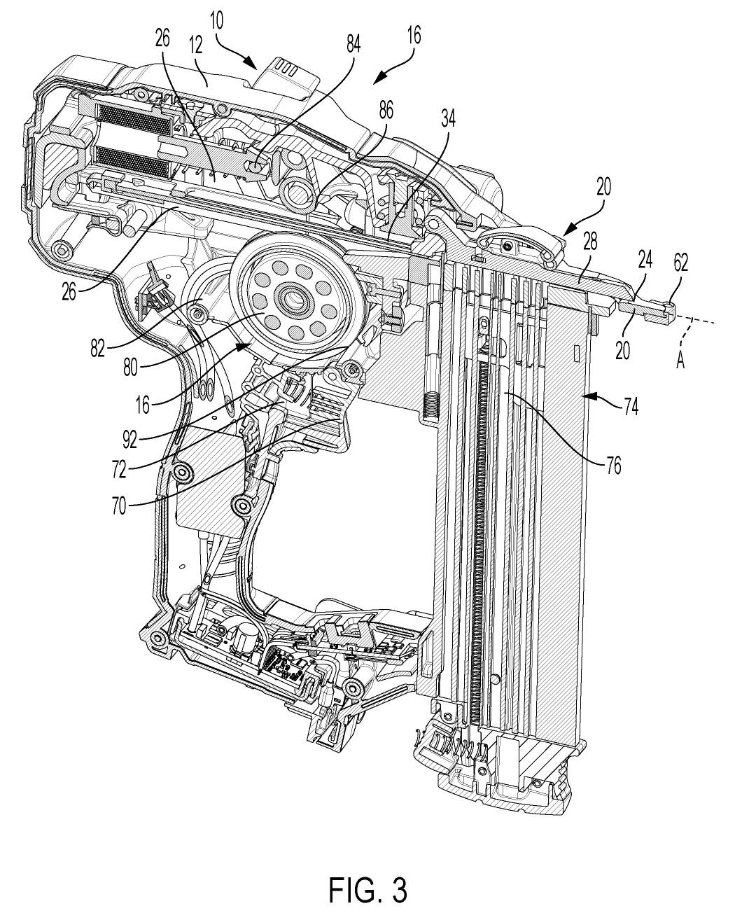

As shown in FIGS. 2 and 3, the drive motor assembly 16 may include a motor 80 and a flywheel 82 that are operable for propelling the driver member 30 in a first direction along the drive axis A. In the embodiments herein, the first direction is a forward direction toward the nose portion 22 of the tool 10. The motor 80 is operably coupled to the flywheel 82 to rotate the flywheel 82. For example, the motor 80 can be an outer rotor brushless motor where the flywheel 82 is an integral part of the outer rotor. Alternatively, motor 80 can be drivingly coupled to flywheel 82 via a transmission (not shown).

Also, as shown in FIG. 2, mounted to the frame 14 are a carrier 54 that supports a follower assembly 84, including a pinch wheel or follower 86. The follower assembly 84 has a locked over-center position in which the driver member 30 can be pinched between the follower 86 and the flywheel 82, subjecting the driver member to a pinch force when the driver member is in the stall position.

The drive motor assembly 16 also includes a return mechanism 88 that returns the driver member 30 to the returned position. The return mechanism 88 can include return springs 90 that compress to absorb the return force applied by the driver member 30. The return springs 90 are compressed during the drive stroke and operate to bias the driver member 30 to the returned position during the return stroke.

The drive motor assembly 16 may be actuated by the control module 18 to cause the driver member 30 to translate and impact a fastener in the nosepiece assembly 20 so that the fastener may be driven into the workpiece. The control module 18 is configured to control a supply of power from the battery to the motor 80 to initiate and activate the drive cycle upon receipt of the trigger signal. In an embodiment, the control module 18 moves the follower 86 that is associated with the follower assembly 84, which squeezes the driver member 30 into engagement with the flywheel 82 so that energy may be transferred from the flywheel to the driver member to cause the driver member to translate. In this way, the control module 18 is arranged to initiate frictional engagement between the outer rim 92 of the flywheel 82 and the driver profile 36 to transmit energy from the flywheel 82 to the driver member 30 to accelerate the driver along the drive axis A for the drive stroke. The nosepiece assembly 20 guides the fastener as it is being driven into the workpiece.

In addition to the driver member 30 being movable along a drive axis A from a returned position to an extended position to drive a fastener, the driver member 30 is also movable in a radial direction relative to the flywheel 82 between an engaged or firing position (FIG. 2) and a home position (FIG. 3). In the firing position, the driver member 30 is drivingly engaged against the flywheel 82. In the home position, the driver member 30 is radially further away from the flywheel 82 than in the firing position.

The drive track 24 receives a first fastener of a collated strip of fasteners and guides the fastener out of the nosepiece assembly 20 when the fastener to be driven into a workpiece is struck by the driver member 30.

In an embodiment, a no-mar tip 62 can be attached to the nose portion 22 of the nosepiece assembly 20 to prevent marring of the workpiece when the nose portion is placed against the workpiece for driving the fastener. Additionally, a nose door 28 is provided on the nose portion 22 to trap a portion the driver member 30 between it and the nose portion 22.

A handle portion 64 of the tool extends from the housing 12. The handle 64 is configured to be received by a user’s hand, thereby making the fastening tool portable. Additional portability can be achieved by constructing the housing from a lightweight yet durable material, such as magnesium. The handle 64 includes a connecting portion 66 and a housing extension 68 that extends substantially parallel to the handle 64.

As shown in FIG. 3, a trigger assembly 70 is connected to the handle 64. The trigger assembly 70 serves as an actuation device or actuator for the fastening tool, and is constructed and arranged to actuate a switch assembly 72. The trigger switch can be part of the control module that includes sensors that sense the state of various components, such as the trigger, and generates signals in response thereto.

The trigger assembly 70 may be coupled to the housing 12 and is configured to receive an input from the user, typically by way of the user's finger, that may be employed in conjunction with the trigger switch assembly 72 to generate a trigger signal that may be employed in part to initiate the drive cycle of the fastening tool to drive the fastener into the workpiece.

The magazine assembly 74 is connected to the nose portion 22 of the nosepiece assembly 20 at one end and is connected to the connecting portion 66 of the housing 12 at an opposite end. The magazine assembly 74 is constructed and arranged to feed successive leading fasteners along a fastener channel 76 and into the drive track 24. In an embodiment, the supply of fasteners can be collated fasteners. The supply of fasteners is urged toward the drive track 24 by at least one magazine pusher or a plurality of magazine pushers that are slidably disposed in the magazine assembly 74. The magazine pusher travels along the magazine pusher path or the fastener channel 76. The fastener channel 76 has a width that accommodates the fasteners. The fastener channel 76 extends into the nose portion 22 of the nosepiece assembly 20. The magazine pusher is biased towards the drive track 24 by a spring or plurality of springs. The magazine pusher engages the last fastener in the supply of fasteners to thereby feed individual fasteners from the fastener channel 76 in the magazine assembly 74 to the fastener channel in the nose portion 22.

In an embodiment, the fastening tool 10 is battery powered. A battery mount 78 is provided for removably mounting a battery pack (not shown) to the fastening tool 10.

The driver member 30 is movable within the drive channel 26 relative to the frame 14 between a returned position and an extended position. The driver member 30 includes a driver body 32 at one end and a driver blade 34 for striking the head of a fastener during the drive stroke at an opposite end. The driver blade 34 is connected to the driver body 32 at a proximal end 34a and has a free distal end 34b configured to contact a head portion of the fastener.

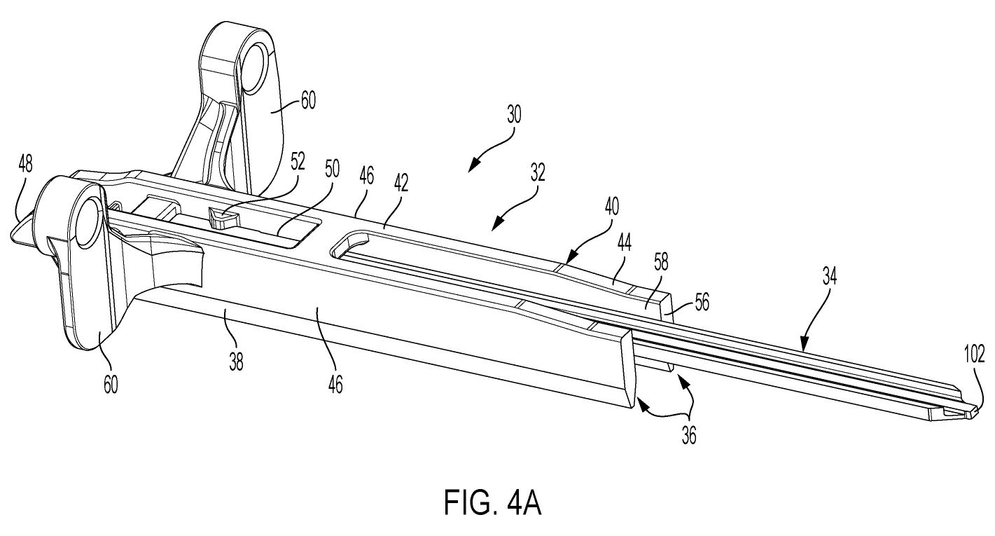

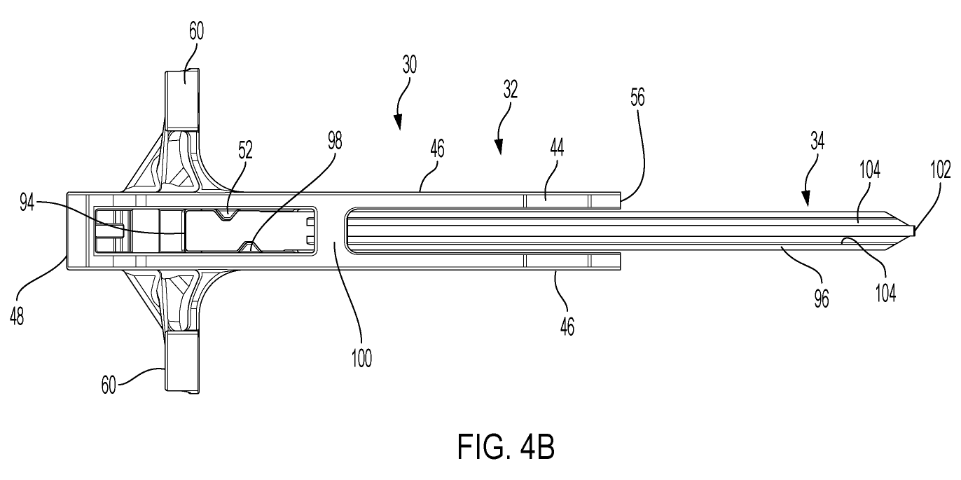

The driver body 32 includes an upper surface 110, a lower surface 112, and an intermediate surface 114 between the upper surface and the lower surface. As shown in FIGS. 4A and 4B, the driver body 32 of the driver member 30 may include a driver profile 36 on the lower surface 112, a cam profile 40 on the upper surface 110, an abutment 48 on the rear surface, a blade recess 50 open to the upper surface, and a blade aperture 116 for receiving the blade into the driver body 32. A center portion of the upper surface 110 is parallel to the lower surface 112. The intermediate surface 114 is substantially parallel to both the center portion of the upper surface 110 and the lower surface 112. A pocket or cavity 118 is located within the intermediate surface 114.

With additional reference to FIG. 4A, the driver profile 36 is disposed on the flywheel side of driver member 30 and is shaped to engage the exterior surface of the outer rim 92 of the flywheel 82, so that the flywheel can deliver kinetic energy to propel the driver member 30.

With additional reference to FIGS. 4A and 4B, the driver profile 36 forms a lower contour of the driver body 32 and is configured in a manner that is complementary to the exterior surface of outer rim 92 of the flywheel 82. In the particular example provided, the driver profile 36 includes a pair of longitudinally extending V-shaped teeth 38 that cooperate to form at least one passage therebetween. The exterior surface of the outer rim 92 of the flywheel 82 has complementary V-shaped teeth and grooves 93 that mesh with the driver profile. As such, the driver profile 36 is configured for engaging grooves 93 on the flywheel 82. The outer rim 92 of the flywheel and the driver body, respectively, provide a space into which the V-shaped teeth, respectively, may extend as the exterior surface of the outer rim of the flywheel 82 and/or the driver profile 36 wear away to thereby ensure contact between the exterior surface and the driver profile along a substantial portion of the V-shaped teeth, rather than point contact.

To further control wear, a coating may be applied to the driver body 30 at one or more locations, such as over the driver profile 36 and the cam profile 40. The coating may be a type of carbide, such as titanium carbide, and may be applied via a plasma spray, for example. Alternatively, a ferric nitro carburizing heat treatment or coating can be used.

With further reference to FIGS. 4A and 4B, the cam profile 40 of the driver body 32 is located on the follower or upper surface of the driver member 30 opposite the driver profile 36 which is on the lower surface of the driver member. The cam profile 40 includes a raised cam profile 42 and a transition cam profile 44 against which the follower 86 engages. As the follower 86 rides up the transition cam profile 44, the pinching force acting on the driver member 30 between the follower 86 and the flywheel 82 increases. The raised and transition cam profiles can be formed on a pair of rails 46.

The driver body 32 rear end surface or abutment 48 is disposed a side opposite the side from which the driver blade 34 extends. The abutment 48 may be configured to slope away from the driver profile 36. The driver body has a longitudinal component between the abutment 48 and a forward end 56. The driver body 32 also has a lateral component defined by and between the rails 46.

The blade recess 50 may be a longitudinally extending cavity that may be disposed between the rails 46 of the cam profile 40. The blade recess may define a blade recess engagement structure for engaging the driver blade. The blade recess engagement structure includes teeth 52 which may be located on opposite lateral sides of the blade recess. In the example provided, the blade recess engagement structure defines a serpentine-shaped channel, having a flat bottom. The teeth 52 engage a corresponding surface at the rear or proximal portion or end 34a of the driver blade 34.

The driver body 32 is open at the forward end 56 and there is a space between the inner sides 58 of the rails 46 and the driver blade 34. The opening extends longitudinally through a portion of the driver body and defines the blade recess 50 at an opposite closed end. The open forward end 56 is defined by the rails 46. The driver body 32 can be closed at the abutment 48 at the rear end.

The driver body 32 has a pair of projections or ears 60 at the rear end adjacent to the abutment 48 that extend laterally on each side. The ears 60 are used to stop forward movement of the driver member 30 after a fastener has been installed in a workpiece. The ears 60 define a contact surface that may be planar in shape, and which may be generally orthogonal to the longitudinal axis of the driver member 30. In an embodiment, the pair of ears 60 are generally parallel to one another and disposed on opposite lateral sides of the driver profile 36.

The distal end of the driver blade 34 can contact against the head of a fastener and drive the fastener as the driver member 30 moves to its axially extended position. In the axially extended position, the ears 60 of the driver member 30 can contact against housing bumper members 104.

The driver blade 34 itself may include a retaining portion 94 and a blade body 96. The retaining portion 94 secures the driver blade 34 to the driver body 32 and may be configured to inhibit movement of the driver blade relative to the driver body in a direction that is generally transverse to the longitudinal axis of the driver member.

The retaining portion 94 may include a corresponding blade engagement structure that is configured to engage the blade recess engagement structure or teeth 52 in the driver body. In the particular example provided, the corresponding blade engagement structure includes a plurality of blade teeth 98 that are received into the serpentine-shaped channel of the blade recess 50 and into engagement with the teeth 52 that form the blade recess engagement structure. Engagement of the blade recess engagement structure or teeth 52 and the blade engagement teeth 98 substantially inhibits motion between the driver blade 34 and the driver body 32.

Returning to FIGS. 4A and 4B, the blade portion 34 extends from the retaining portion 94 and through the blade aperture in the driver body 32. The blade aperture is under a bridge 100 that connects the two sides of the driver body 32. The blade body 96 of the driver blade 34 may include a tip portion 102 at a distal end. The tip potion 102 is planar in a conventional manner (e.g., on the side against which the fasteners in the magazine assembly 74 are fed) and tapered on its laterally opposite sides. The blade body 96 also has a plurality of grooves 106 on the nose door side which is opposite to the side against which the fasteners in the magazine assembly 74 are fed.

The driver body 32 may be unitarily formed in an appropriate process, such as investment casting, from a suitable material, such as a ferromagnetic material. In an embodiment, the driver body 32 and the driver blade 34 can be formed of a metal including, but not limited to steel and titanium.

In operation, fasteners are stored in the magazine assembly 74, which sequentially feeds the fasteners into the nosepiece assembly 20 and positions fasteners in line with the driver member 30. The drive motor assembly 16 as actuated by the control module 18 causes the driver member 30 to translate and impact a fastener in the nosepiece assembly so that the fastener may be driven into a workpiece. Actuation of the motor 80 may be by use of electrical energy from the battery pack (not shown) to operate the motor 80 of the drive motor assembly 16, the control module 18 and the trigger assembly 70. The motor 80 is employed to drive the flywheel 82.

With driver body 32 being open at the forward end 56 on the fastener driving direction side of the tool, during the drive stroke, the driver body is able to overlap the fastener channel. During the drive stroke, and while the follower assembly squeezes the driver member into engagement with the flywheel, the driver body 32 straddles the fastener channel 76 through the nose portion 22 and the magazine 74, and the forward surface 56 of the driver member 30 overlaps the fastener channel in a direction parallel to the drive axis A.

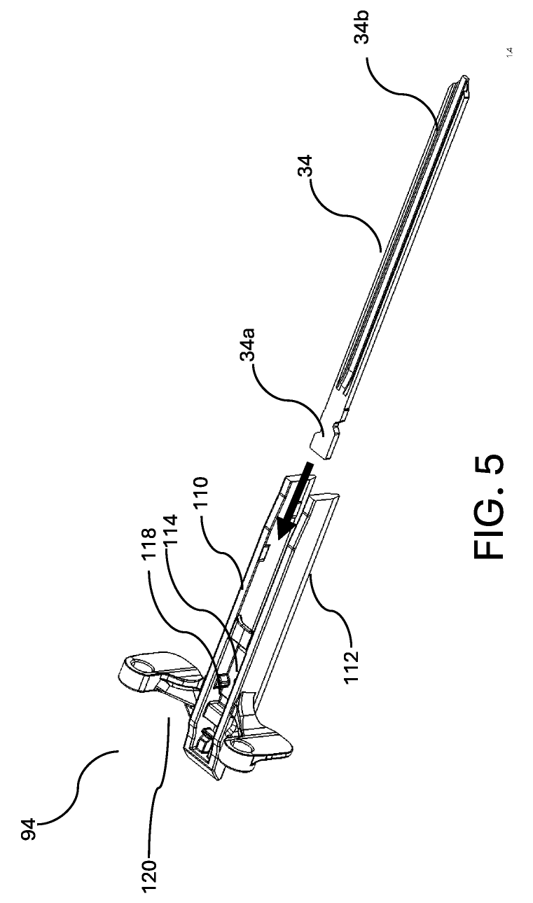

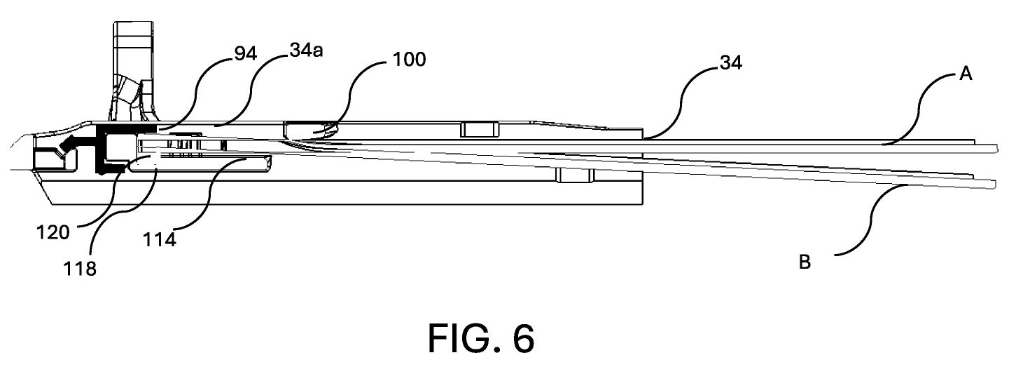

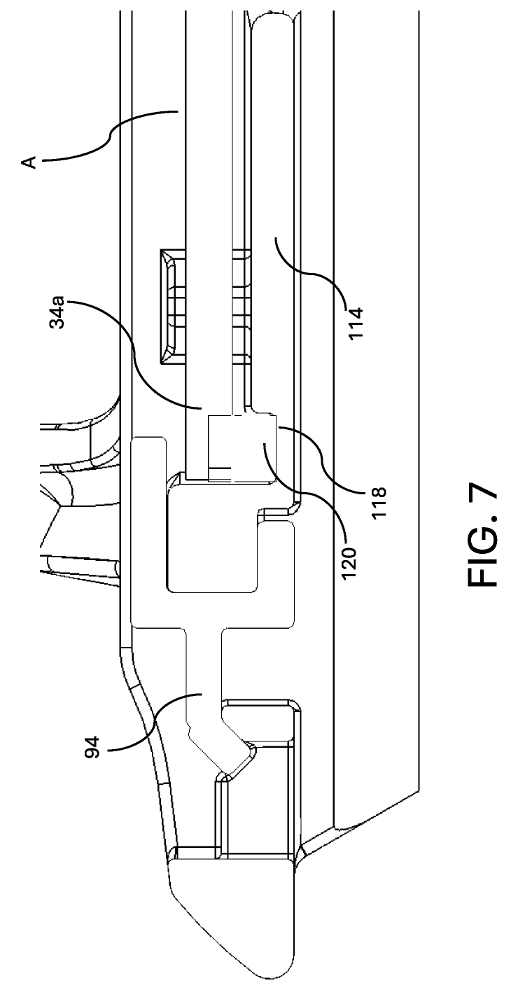

With reference to FIGS. 5, 6, and FIG. 7, in an embodiment of the present invention, the driver member 30 has a driver profile 36 that interacts with the flywheel 82, and a driver blade that interacts with a fastener or nail. The driver blade 34 can be connected to the driver profile 36 by a retaining member. In an embodiment, the retaining member can be a clip. In order to reduce the length of the driver profile 36 so that it does not contact the flywheel 82 when the driver member 30 is at rest, a biasing member in the form of a lifter spring 120 can be provided between the driver blade 34 and the driver profile 36. The lifter spring 120 is disposed within the cavity 118 in the intermediate surface 114 and configured to bias the proximal end 34a of the driver blade 34 in a direction of the upper surface 110 of the driver body. The biasing member 120 also applies a force between the driver blade 32 and the intermediate portion 114 on the driver body 32. As shown in FIG. 6, in the lifted position B the distal end 34b is closer to the profile 36 than it is in the driving position A.

The lifter spring 120 can have a coil body or a foam body. The coil body can be a compression spring formed from a metal. The foam body can be a material including, but not limited to polypropylene, polyethylene, polyurethane elastomer such as CELLASTO®.

Alternatively, the lifter spring 120 can be disposed around the retaining member that connects the driver profile 36 and the driver blade. However, the lifter spring 120 merely needs to be located under the driver blade and anywhere between the bridge and the retaining member.

The lifter spring 120 can raise the connected end of the driver blade away from the surface of the driver profile 36 so that the driver blade can rotate about an axis normal to the center-plane of the tool. The spring between the driver blade and the driver profile 36 can rotate the driver profile 36 relative to the driver blade about this axis. The spring bias causes a reaction force between the driver blade and the nailer nose, whereby the nailer nose can push the driver blade tip up (in the direction of the spring bias) to keep the driver blade straight. The middle portion of the driver blade is constrained by a window between a bridge 100 and a serpentine cutout on the driver profile 36. Therefore, when the lifter spring 120 causes the driver blade to rotate, the blade rotates about the point of contact at the bridge 100. As a result, the connected driver profile 36 is also lifted away from the flywheel and contact is prevented.

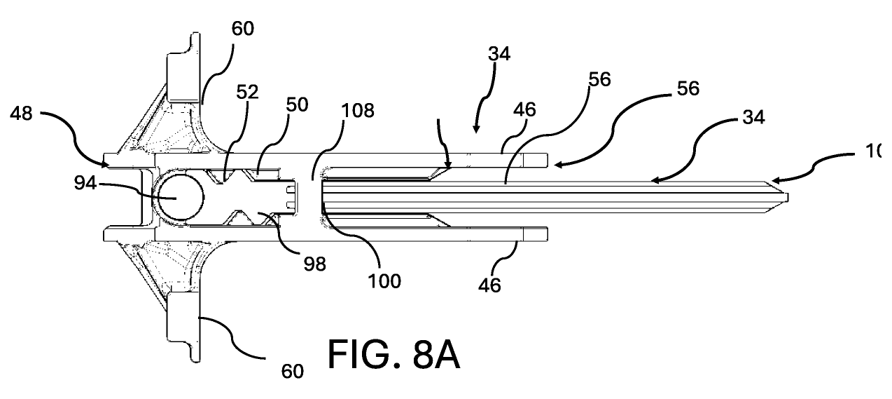

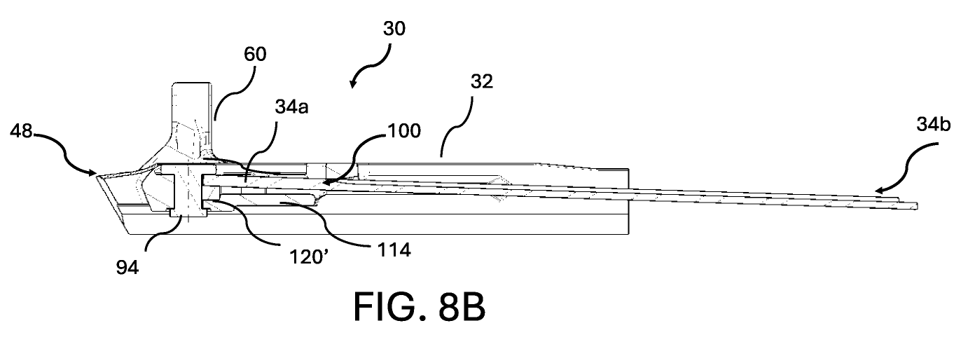

With further reference to FIGS. 8A and 8B, in a second embodiment of the present invention, the driver blade can be connected to the driver profile 36 by a rivet. The lifter spring 120’ can be disposed around the rivet.

While the fastening tool is illustrated as being electrically powered by a suitable power source, such as the battery pack, those skilled in the art will appreciate that the invention, in its broader aspects, may be constructed somewhat differently and that aspects of the present invention may have applicability to any type of portable tool including a pneumatic nailer pneumatically powered fastening tools. Furthermore, while aspects of the present invention are described herein and illustrated in the accompanying drawings in the context of a nailer, those of ordinary skill in the art will appreciate that the invention, in its broadest aspects, has further applicability. For example, the drive motor assembly may also be employed in various other mechanisms that use reciprocating motion, including rotary hammers, hole forming tools, such as punches, and riveting tools, such as those that install deformation rivets.

While aspects of the present invention are described herein and illustrated in the accompanying drawings in the context of a fastening tool, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

I claim:

1. A driver member for driving a fastener into a workpiece, the driver member comprising:
a driver body having an upper surface, a lower surface and an intermediate surface between the upper surface and the lower surface;
a driver blade having a proximal end operatively connected to the driver body and a distal end configured to contact a head portion of the fastener;
a cavity located within the intermediate surface; and
a biasing member disposed within the cavity and configured to bias the proximal end of the driver blade in a direction of the upper surface of the driver body.

2. The driver member according to claim 1, wherein the cavity is open toward the driver blade.

3. The driver member according to claim 1, wherein the cavity has a shape that corresponds to the shape of the biasing member.

4. The driver member according to claim 1, wherein the biasing member is a foam spring.

5. The driver member according to claim 1, wherein the biasing member applies a force between the driver blade and the intermediate portion.

6. The driver member according to claim 1, wherein the driver body further comprises a bridge portion disposed laterally across the upper surface.

7. A tool for driving a fastener into a workpiece, the tool comprising:
a housing having a drive channel;
a nosepiece assembly connected to a forward end of the housing and having a nose portion that extends in a longitudinal direction;
a driver member provided in the housing and configured for movement within the drive channel in a longitudinal direction, the driver member having a driver blade configured to drive the fastener into the workpiece, the driver blade having a retained end and an opposite free distal end; and
a biasing member disposed within the driver member and configured to bias the retained end of the driver blade in a direction normal to the longitudinal direction.
